(19) United States
(12) Patent Application Publication
(10) Pub. No.: US 2004/0070174 A1
(43) Pub. Date: Apr. 15, 2004

(54) Towbar for storage carts

(76) Inventor: Jorge Cortez, San Diego, CA (US)

Correspondence Address: Eastman & Associates, Suite 1800, 707 Broadway Street, San Diego, CA, 92101, US

(21) Appl. No.: 10/628,084

(22) Filed: Jul. 24, 2003

Related U.S. Application Data
(63) Continuation-in-part of application No. 10/206,657, filed on Jul. 29, 2002, now abandoned.

(51) Int. Cl. B60D 1/00

(52) U.S. Cl. 280/495; 280/491.1

(57) ABSTRACT

A towbar for storage carts includes an adjustable width base which may be expanded to attach to vertically positioned frame members of a storage cart, and also includes a tongue assembly which attaches to the base and pivots such that the tongue assembly may be raised or lowered to accommodate attachment of the towbar for storage carts to motorized vehicles having differing heights.

### RELATED APPLICATIONS

This application is a continuation-in-part of United States Utility Patent Application filed Jul. 29, 2002, having Ser. No. 10/206,657, entitled “Chair Truck Towbar” and currently co-pending.

### FIELD OF THE INVENTION

The present invention relates generally to devices for attaching moving carts to those vehicles that move them. The present invention is more particularly, though not exclusively, useful as an adjustable attachment towbar for temporarily attaching moving carts having varying sizes to a vehicle.

### BACKGROUND OF THE INVENTION

Convention centers and banquet halls are in the business of providing locations for entertainment and conventions. Quite often this entertainment and convention business requires the setting up and taking down of large numbers of chairs and tables. Further, the close scheduling of different events often requires that the taking down and reconfiguring of the halls be done within only a few hours.

Despite the very difficult challenge of placing hundreds of tables, and possibly thousands of chairs in a banquet hall, most convention centers still require that their facilities personnel manually roll the carts containing the chairs and tables into the banquet halls. This manual movement causes both a delay in setting up the hall, and also leads to increased risk of physical injury to facilities personnel.

In an effort to increase the rate at which the chairs and tables may be brought into the banquet hall, the manufacturers of the chairs and tables may provide custom-built carts to fit that particular manufacturer's tables and/or chairs. One example of such a cart is depicted in United States Patent Application Serial Number US2001/0013690 entitled “Cart For Folding Tables” filed by K. Sexton et al, and which was published on Aug. 16, 2001. In one embodiment, the Sexton cart is shown to be constructed of tubular metal and having a width suitable for the tables being placed on the cart.

Unfortunately, because each of the carts provided by the various manufacturers of chairs and tables has a unique size and construction, it is difficult to attach the cart to a powered vehicle, such as a fork lift or motorized cart. Attempts to attach the cart to a vehicle with rope, or other flexible materials, results in a dangerous situation which may lead to the injury of the facilities personnel. These injuries include being pinched between the cart and the vehicle, being struck by the side-to-side swaying of the cart, or by being stuck with rope fragments should the tow rope snap due to the excessive tension. This difficulty is greater in circumstances where third-party carts are used as their cart size and construction varies from the table and chair manufacture carts. These challenges result in the facilities personnel having to manually roll one cart at a time into the banquet hall for unloading and/or loading.

In light of the above, it would beneficial to provide a device for attaching a table or chair storage cart, having virtually any size, to a motorized vehicle. It would be further beneficial to provide a device that would also serve to maintain a safe distance between the motorized vehicle and the table or chair cart to minimize the possibility for injury to persons caught between the vehicle and the cart.

### SUMMARY OF THE INVENTION

The present invention includes a towbar for storage carts for temporarily attaching a chair or table storage cart to a motorized vehicle, such as an electric pulling cart, for transportation into or out of a convention center or banquet hall. The present invention includes an adjustable width base which may be expanded to attach to vertically positioned frame members of nearly every table or chair cart in the industry. In a preferred embodiment, the present invention also includes a tongue assembly which attaches to the base and pivots such that the tongue assembly may be raised or lowered to accommodate motorized vehicles having differing heights. The tongue assembly includes a tongue ring which is received by most motorized vehicles equipped with a tow hitch. During periods when the cart is not attached to a motor vehicle, the tongue assembly may be raised and safely positioned against the storage cart thereby eliminating opportunities for injury due to tripping or walking into the lowered tongue assembly.

In an alternative embodiment, the present invention includes a towbar for storage carts having a base with a fixed tongue assembly. The fixed tongue assembly is configured such that two of the towbars for storage carts of the present invention may be attached together to connect the separate carts together in a train-like manner in order for the simultaneous towing by a single motorized vehicle. This is particularly useful in circumstances where more than one storage cart is needed.

The present invention also includes the combination of a towbar for storage carts having a pivoting tongue assembly with a towbar for storage carts having a fixed tongue assembly. This accommodates the connection of carts having differing heights, yet prevents the towbar for storage carts from striking the ground while the two carts are being moved.

In an alternative embodiment, the present invention includes a towbar for storage carts which has been designed to connect a three-wheeled electric pulling car with storage carts filled with tables, chairs and similar equipment. These carts are commonly used in convention centers, large hotels, educational settings, or wherever larger groups of people are assembled for meetings or banquets.

By using simple locking pins the towbar connects directly to the frame of the cart that is being pulled. No additional parts or connecting devices are required on the carts. By moving the pins the towbar can be expanded to facilitate storage carts varying in sizes from, for example, approximately 39 inches to 43 inches. The towbar is secured to the puling electric car by a circular locking ring that can fit on any standard locking mechanism. The towbar is completely portable and can be lifted from the motorized car when not in use. Also when the towbar for storage carts is not being used, it can be easily removed, or it may remain connected to the pulling car and secured to its rear by simple hooks. The hitch is then anchored in an upward position and cannot drag on the floor, or create a hazard for injury.

### BRIEF DESCRIPTIONS OF THE FIGURES

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a towbar for storage carts of the present invention and includes a mounting base having a left base extension and a right base extension each equipped with an attachment fork for receiving a vertical storage cart rail, and having a pivoting tongue assembly for attachment to a pulling car;

FIG. 2 is a top view of the towbar for storage carts of the present invention and showing the mounting base with the left and right base extensions in a first, narrow, configuration, and extended outward in a second, wider, configuration depicting the ability to attach the present invention to storage carts having different widths;

FIG. 3 is a top view of an alternative embodiment of the towbar for storage carts of the present invention showing a mounting base with a fixed tongue assembly extending from the mounting base and having a pair of receiving brackets for connection to a pulling vehicle, or to another towbar for storage carts of the present invention;

FIG. 4 is a side view of the tongue assemblies of two towbar for storage carts of the present invention, and includes two sets of receiving brackets which provide for the attachment of two towbar for storage carts together, yet allows for rotation about the connecting pin;

FIG. 5 is a top view of two towbars for storage carts of the present invention in a cart-connection configuration useful for connecting two storage carts together while allowing for the rotation of the two towbars about their connecting pin;

FIG. 6 is a side view of an application of the towbar for storage carts of the present invention showing two towbars for storage carts being used to connect two carts together;

FIG. 7 is a side view of an application of the towbar for storage carts of the present invention showing the towbar being mounted to a storage cart and attached to a pulling vehicle;

FIG. 8 is a detailed drawing of the attachment fork of the towbar for storage carts of the present invention showing a vertical frame member from a typical storage cart positioned within the fork and secured in place with a retaining bolt which provides for the secure attachment of the towbar for storage carts to storage carts having a wide range of frame dimensions and for positioning the towbar for storage carts at a fixed height from the floor; and

FIG. 9 is a perspective drawing of the towbar for storage carts of the present invention as installed on a typical chair storage cart showing the accommodation for carts having differing widths, and for setting the height of the towbar for storage carts a predetermined, fixed distance from the floor.

### DETAILED DESCRIPTION OF THE PRESENT INVENTION

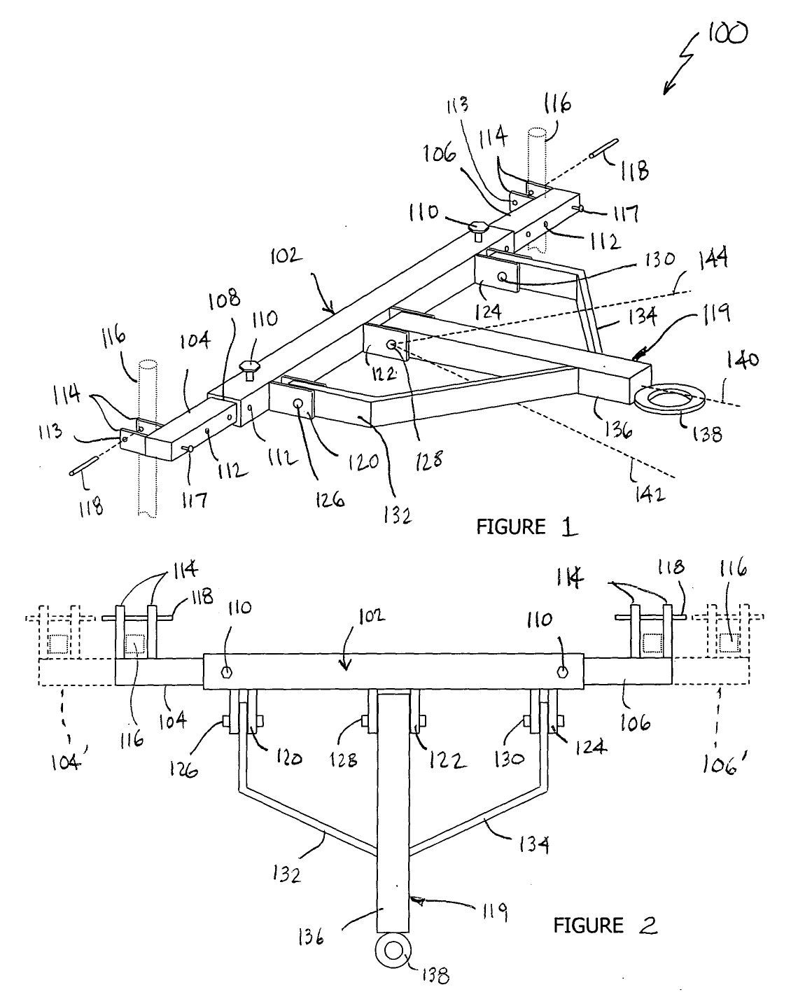

Referring initially to FIG. 1, the towbar for storage carts of the present invention is shown and generally designated 100. Towbar for storage carts 100 includes a mounting base 102 having a left base extension 104 and a right base extension 106 slidably disposed within a lumen 108 formed within base 102. Base extensions 104 and 106 may be slidably positioned within lumen 108 to define a width (discussed more thoroughly in conjunction with FIG. 9), and then secured in place with threaded locking screws 110. Alternatively, or in conjunction with threaded locking screws 110, base 102 and base extensions 104 and 106 may be formed with bores 112 which may be aligned and secured in place with a pin (not shown this Figure) to maintain a certain width. In a preferred embodiment of the present invention, the placement of the bores 112 may correspond to cart widths common in the industry, or for larger suppliers of chair and table storage carts.

At the distal end of each base extension is an attachment fork 114 formed and sized to receive a structural member, such as a vertical frame member 116, of a storage cart. Once the frame member 116 is in position within the attachment fork 114, a locking pin 118 is inserted into bores 113 formed in the attachment fork 114. Once securely locked within the attachment fork 114, the frame member 116 may be further secured using retaining screw 117 to capture the frame member 116 between the locking pin 118 and the retaining screw 117.

Tongue assembly 119 is pivotally attached to base 102 with pivot brackets 120, 122 and 124. More specifically, each bracket 120, 122, and 124 is formed with a pivot pin 126, 128 and 130, respectively. Bracket 120 receives left tongue support 132 and bracket 126 receives right tongue support 134, and bracket 122 receives tongue 136. It is to be appreciated that pivot pins 126, 128, and 130 are all co-linear which provides for the pivoting of tongue assembly 119 about pivot pins 126, 128, and 130. This pivoting provides for the possible positioning of tongue 136 from a substantially horizontal position 140, to a lowered position 142, to a raised position 144, and allows the towbar for storage carts to be used with motorized carts having different heights. Also, tongue assembly 119 may be safely positioned vertically upwards during periods when not attached to the pulling vehicle.

Tongue 136 is formed with a tongue ring 138 for attachment to a motorized car, such as an electric cart. It is to be appreciated that alternative attachment mechanisms which are known in the art are fully contemplated herein, including but not limited to the ball and socket type hitch.

Referring now to FIG. 2, a top view of the towbar for storage carts of the present invention is shown. Mounting base 102 is configured with the left and right base extensions 104 and 106 in a first, narrow, configuration to accommodate a storage cart having a more narrow width. In an alternative configuration, left and right base extensions 104 and 106 have been extended outwards to positions 104′ and 106′ respectively (shown in dashed lines) to accommodate storage carts having a greater width. It is to be appreciated that base extensions 104 and 106 may be extended to accommodate carts having virtually any width as the length of base 102 and base extensions 104 and 106 as depicted in the Figures is merely exemplary of a preferred embodiment and no limitation as to the actual dimensions of the towbar for storage carts whatsoever is stated or implied.

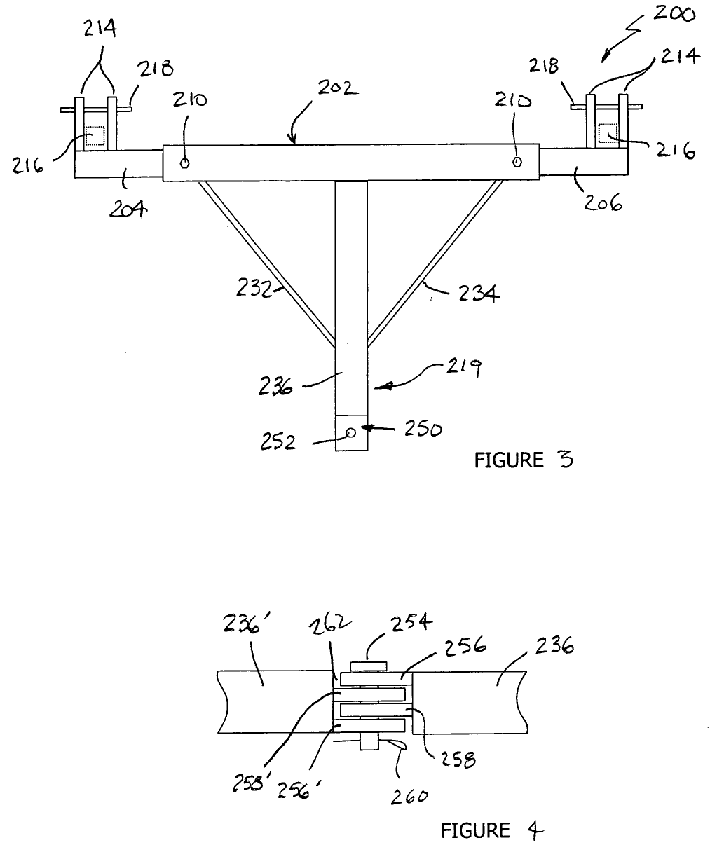

Referring to FIG. 3, a top view of an alternative embodiment of the towbar for storage carts of the present invention is shown and generally designated 200. Towbar for storage carts 200 includes a mounting base 202 having a lumen to receive left and right base extensions 204 and 206, and held in place with locking screws 210. As with towbar for storage carts 100, towbar for storage carts 200 includes an attachment fork 214 on each base extension 204 and 206 to receive a frame member 216 of a storage cart. Frame members 216 are secured within attachment fork 214 with retaining pins 218. It is to be appreciated that other methods known in the art for attaching base extension 104 and 106 to frame rails 116 are contemplated herein, including but not limited to, Velcro straps, magnetic attachment pads for engaging metal frame rails, mechanical clips, and/or other mechanisms known in the art.

Towbar for storage carts 200 includes a fixed tongue assembly 219 which includes fixed tongue supports 232 and 234 fixedly attached to tongue 236 and base 202 to maintain tongue 236 in a fixed relationship to base 202. Tongue assembly 219 is formed with an attachment mechanism 250 formed with a bore 252 and is intended to attach to a similar towbar for storage carts 200, or to a motorized car. More specifically, referring to FIG. 4, tongue assembly 219 at its distal end is formed with a lateral tab 256 and a medial tab 258, each formed with a bore 252.

As configured, a first towbar for storage carts 200 having tabs 256 and 258 can be attached to a first storage cart, and a second towbar for storage carts 200 having tabs 256′ and 258′ can be attached to a second storage cart, and by installing a connecting pin 254 through bore 252, the two towbar for storage carts 200 can be securely attached and a train of storage carts may be formed. Securing connecting pin 254 within bore 252 may be accomplished with a safety pin, such as a cotter pin 260, in order to inhibit the removal or accidental displacement of pin 254 from bore 252.

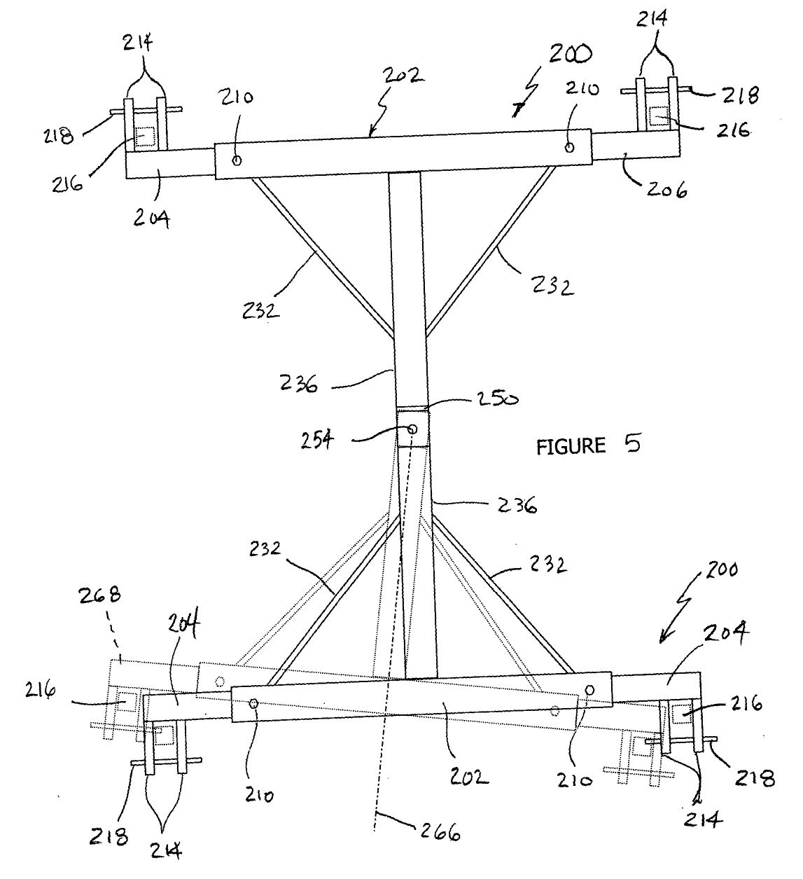

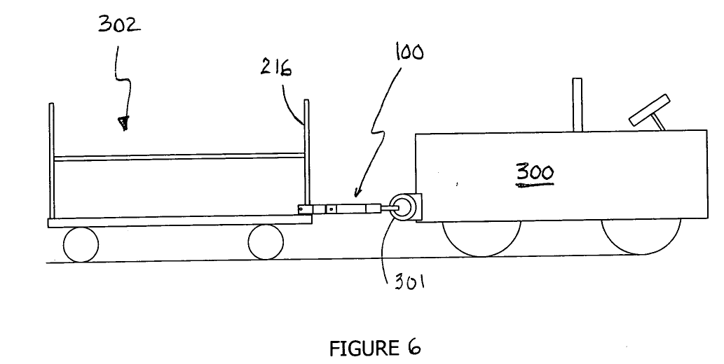

Sufficient gaps 262 may be formed in tongue 236 to provide for the extensive rotation of the first towbar for storage carts 200 with respect to the second towbar for storage carts 200 about pin 254. For example, referring to FIG. 5, a first towbar for storage carts 200 is shown attached to a second towbar for storage carts 200. As shown by the alternative position of towbar for storage carts 200 indicated by dashed lines 268, towbar for storage carts 200 can rotate about pin 254. The configuration shown in FIG. 5 is defined as a cart-connection configuration useful for connecting two storage carts together while allowing for the rotation of the two towbars about their connection pin.

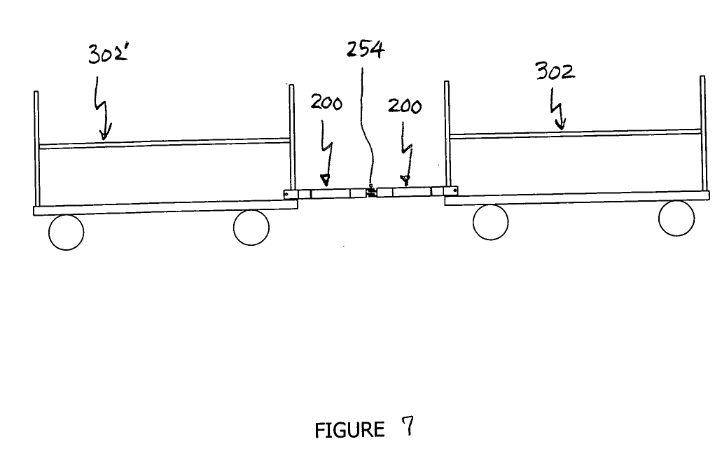

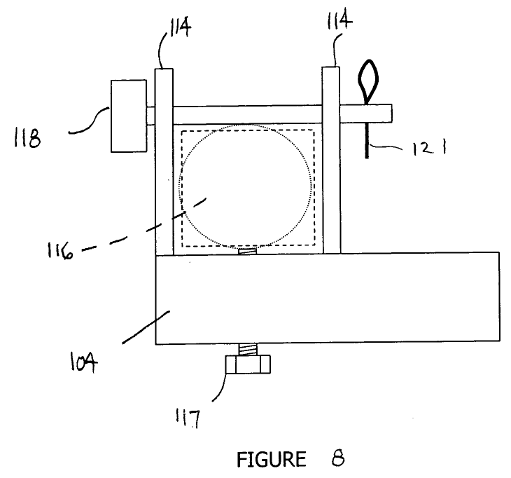

Referring to FIG. 6, a side view of an application of the towbar for storage carts 100 of the present invention is shown. In this Figure, a typical storage cart 302 is shown equipped with the towbar for storage carts of the present invention 100, and securely attached to a typical motorized cart 300. From this Figure, it can be appreciated that hitch 301 on motorized car 300 is the type to receive a tongue ring 138. However, it is to be further appreciated that additional types of hitches may be used without departing from the spirit of the present invention.

FIG. 7 is a side view of an application of the towbar for storage carts 200 of the present invention showing two towbars for storage carts 200 being used to connect two carts together. In this configuration, storage cart 302 can rotate about pin 254 with respect to storage cart 302′.

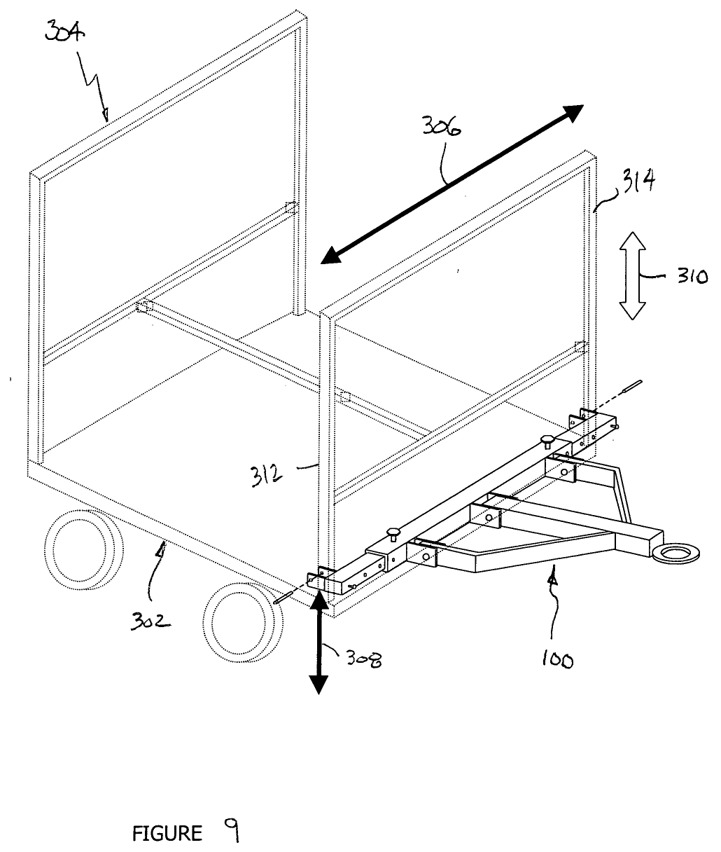

Referring now to FIG. 8, a detailed drawing of the attachment fork 114 of the towbar for storage carts 100 and 200 of the present invention shows the placement of a vertical frame member 116 from a typical storage cart positioned within the fork 114, and secured in place with a retaining pin 118. Once frame member 116 is in place, it may be advantageous to position the towbar for storage cart of the present invention at a particular location along the length of frame member 116. Retaining bolt 117 passes through a threaded bore in each base extension 104 and 106 and may be advanced or retracted by simple rotation.

The rotation of retaining bolt 117 advances the retaining bolt 117 into the retaining fork 114 and captures frame member 116 between the retaining bolt 117 and retaining pin 118. In this manner, the towbar for storage carts of the present invention may be positioned precisely on the frame member 116 at a predetermined height from the floor. Retaining pin 118 may be equipped with a securing pin 121 for maintaining the retaining pin 118 within attachment fork 114.

Referring to FIG. 9, a perspective view of the towbar for storage carts of the present invention as installed on a typical chair storage cart 302 (shown in dashed lines) is shown. Storage cart 302 is shown to have a frame 304 with a width 306. As attached, the towbar for storage cart 100 of the present invention is positioned on vertical frame rails 312 and 314. More specifically, with reference to FIG. 1, attachment forks 114 of the left and right base extensions 104 and 106 are positioned over frame rails 312 and 314, respectively. Once in position, retaining pin 118 is inserted into bores 113 and the towbar for storage cart 100 is attached to the cart 302.

Once attached, the vertical positioning of the towbar for storage cart 100 is accomplished by moving the towbar for storage cart 100 up or down in direction 310 such that the desired distance 308 from the towbar 100 to the floor is attained. Once positioned at the proper height, set screw 117 may be tightened to capture the frame rail and maintain the towbar 100 for storage cart 100 at the determined height 308.

In some applications, the width of towbar for storage cart 100 may be adjusted for widths 306 of different storage carts. This adjustment may be achieved by loosening locking bolt 118 and sliding the base extensions 104 and 106 within base 102 to achieve the desired width. Once the desired width 306 is achieved, locking bolts 118 are re-tightened to fix the base extensions 104 and 106 within base 102.

While the particular towbar for storage carts as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

I claim:

1. A towbar for use in attaching a storage cart to a vehicle, comprising:
a mounting base formed with a lumen;
a left base extension having an attachment fork and slidable within said lumen;
a right base extension having an attachment fork and slidable within said lumen;
a tongue assembly having a tongue and one or more tongue supports;
a means for pivotally attaching said tongue assembly to said mounting base.
